(19) United States
(12) Patent Application Publication
(10) Pub. No.: US 2014/0219442 A1
(43) Pub. Date: Aug. 7, 2014

(54) SECURE CRYPTO KEY GENERATION AND DISTRIBUTION

(71) Applicant: Fairchild Semiconductor Corporation, San Jose, CA (US)

(72) Inventors: Robert A. Card, Scarborough, ME (US); Jefferson Hopkins, Orrington, ME (US); Christian Klein, Portland, ME (US); Myron J. Miske, Newfields, NH (US); Michael Smith, Weare, NH (US); John R. Turner, Portland, ME (US); Jaeyoung Yoo, Scarborough, ME (US); Nathan Charland, Scarborough, ME (US)

(73) Assignee: Fairchild Semiconductor Corporation, San Jose, CA (US)

(21) Appl. No.: 14/175,035

(22) Filed: Feb. 7, 2014

Related U.S. Application Data
(60) Provisional application No. 61/762,256, filed on Feb. 7, 2013.
(60) Provisional application No. 61/764,865, filed on Feb. 14, 2013.

(51) Int. Cl. H04L 9/08; H04L 9/14

(52) U.S. Cl. CPC H04L 9/0861; H04L 9/14
USPC 380/44

(57) ABSTRACT

This document discusses, among other things, a method of distributing authentication keys that can prevent certain forms of circuit fabrication piracy. In an example, a method can include selecting a number of authentication keys for generation at a key generation computer, generating a random number using a random number generator of the key generation computer, generating the number of authentication keys using the random number and a key generation algorithm stored in the memory of the key generation computer, scrambling each of the number of authentication keys using a scrambling routine executing on the key generation computer, and distributing the scrambled authentication keys to an authorized manufacturers.

### CLAIM OF PRIORITY AND RELATED APPLICATIONS

This application claims the benefit of priority under 35 U.S.C. §119(e) of U.S. Provisional Application Ser. No. 61/762,256, titled, “SECURE CRYPTO KEY GENERATION AND DISTRIBUTION,” filed on Feb. 7, 2013, U.S. and Provisional Application Ser. No. 61/764,865, titled, “SECURE CRYPTO KEY GENERATION AND DISTRIBUTION,” filed on Feb. 14, 2013, each of which are incorporated by reference herein in its entirety.

### BACKGROUND

Just like the fashion industry, electronic products can be copied and sold as a cheap versions of an original manufacturers' product. In an effort to prevent such dilution of a company's product as well as to prevent the loss of sales, or licensing revenue associated with the product or accessory devices that work with the product, electronic companies have begun to use authentication processes to confirm that their master electronic products connect with and use only authentic, authorized versions of certain complementary components or accessories and vice versa. In some cases, chip authentication can rely on authentication keys that need to be distributed to contract chip manufactures or subsidiary divisions that make chips for a master electronic device, an accessory device or both. The keys can then be further distributed within the chip manufacturer before being integrated into the final product. The distribution of the authentication keys can provide excellent opportunities for authentication keys to be compromised and sold to entities capable of integrating the authentication keys in cheap “knock-offs” that can undermine the revenue, market presence, and the future of an innovative electronic manufacturer or electronic design company.

### Overview

This document discusses, among other things, a method of distributing authentication keys that can prevent certain forms of circuit fabrication piracy. In an example, a method can include selecting a number of authentication keys for generation at a key generation computer, generating a random number using a random number generator of the key generation computer, generating the number of authentication keys using the random number and a key generation algorithm stored in the memory of the key generation computer, scrambling each of the number of authentication keys using a scrambling routine executing on the key generation computer, and distributing the scrambled authentication keys to an authorized manufacturers.

This section is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 depicts architecture for generating and distributing crypto keys.

FIGS. 2A and 2B illustrate generally an example method of generating and distributing crypto keys that is less susceptible to unintended release of a crypto key.

FIGS. 3A and 3B illustrate generally apparatus and methods for storing crypto keys in non-volatile memory of an integrated circuit.

FIG. 4 illustrates generally a flowchart of an example method of distributing authentication keys and preventing circuit piracy.

### DETAILED DESCRIPTION

Companies that invent or design electronic devices often have manufacturing facilities located throughout the world to take advantage of a certain regions expertise or low manufacturing costs, for example. In some situations, the company can contract to have certain components or products manufactured. In some situations, the company can design an entire line of electrical products designed to connect with each other and enhance the usability of one or more of the products. Such product lines can be very trend setting and valuable and very attractive for opportunistic entities to make and sell some of the components without authorization of the product line owner.

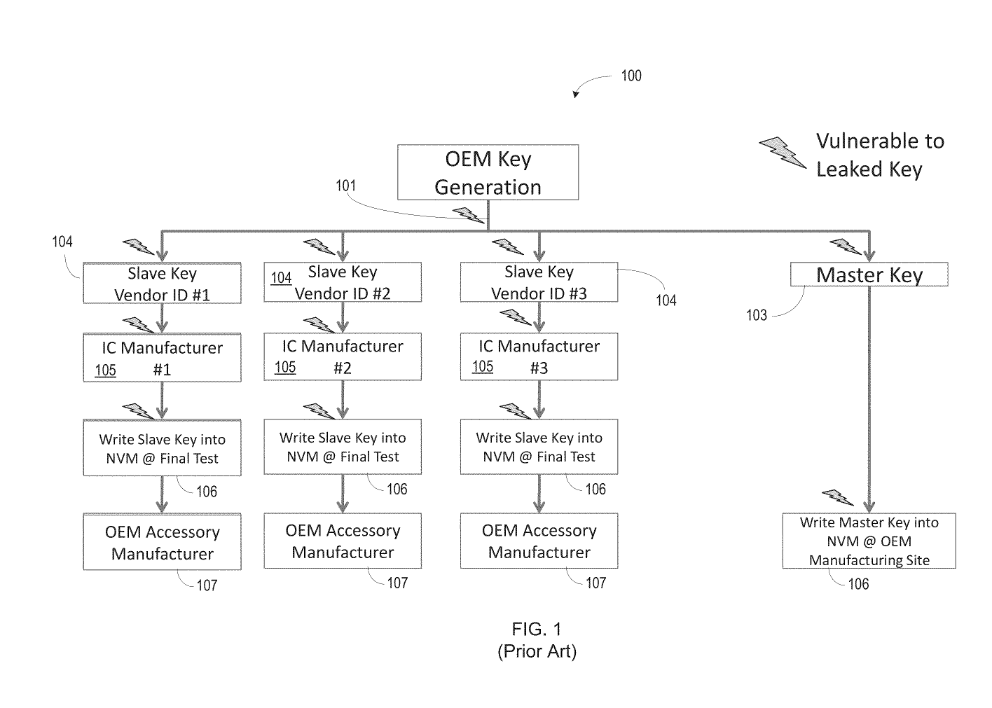

FIG. 1 depicts an system 100 for generating and distributing authentication keys 101 for use in authenticating certain chips in electronic devices. In certain existing architectures, a technology owner can generate authentication keys 101 and can create a file containing the authentication keys 101 for use with products covered by the owned technology. The authentication keys 101 can include one or more master authentication keys 103 and one or more slave authentication keys 104. The authentication keys 101 can be distributed to vendors 105 responsible for, or associated with final testing of integrated circuits used in products and accessories that use the owned technology. At final testing of the integrated circuits 106, an authentication key can be written into memory of the integrated circuit. The integrated circuits can then be forwarded 107 to manufacturers of the master devices, such as a cell phone, tablet, mobile electronic device, etc. and the manufacturers of slave devices such as accessory electronic devices configured to couple to and/or communicate with the master devices.

In the illustrated example, the technology owner can contract with or license other companies or other divisions of the technology owner to fabricate integrated circuits associated with one or more products within a complimentary product line such as interface integrated circuits for a master product and complementary interface integrated circuits for accessory devices configured to couple to the master product and enhance the functionality of the mater product or the user experience of the master product. In certain examples, the chips can be interface chips such as interface chips configured to couple to a communication port of each device.

In certain examples, the technology owner can mandate that whenever a master product couples to an accessory device, an authentication routine takes place to determine whether the accessory is an authorized authentic device and that the master product is an authorized authentic device. To facilitate the authentication process, the technology owner, such as an integrated circuit design company, can generate a number of authentication keys and distribute the keys to the locations where final testing of one or more of the chips used in the master product or the accessories is conducted so that the authentication keys can be saved in memory associated with the chip. In some situations, the authentication keys include one or more master authentication keys, and one or more slave authentication keys. In certain examples, the master authentication keys can be associated with a master product. In certain examples, the slave authentication keys can be distributed to entities associated with designing, fabricating and assembling accessory devices for use with the master device.

Upon connection of an authentic master device with an authentic slave device, one of the devices can provide an authentication challenge to the other device. The authentication challenge can include one or more pieces of challenge data. The challenged device can encrypt the challenge data and return the encrypted challenge data to the other device. The other device can decrypt the challenge data and compare it to expected data to determine whether the challenged device is authentic. If it is determined a device is not an authorized authentic device, the functionality of the challenged device can be ignored by the authentic device in certain examples.

The type of distribution system illustrated in FIG. 1 can provide opportunities for the authentication keys to be observed and or copied. Such observation and copying can lead to one or more authentication keys being leaked to third parties thus creating an opportunity for violation of systems intended to be protected by the authentication keys. Opportunities for the authentication keys to be viewed, thus leaked, are highlighted in FIG. 1 by the locations of the lightning bolts.

For opportunistic counterfeiters, obtaining a master authentication key or a authentication key can be very lucrative as they can then provide discount devices that appear to be authentic to a market that is probably paying a premium for a well-engineered and well-fabricated products authorized and quality controlled by the technology owner. Such lower quality counterfeit products can diminish the user experience of the technology owner's products and can deflate the potential market of the technology owner.

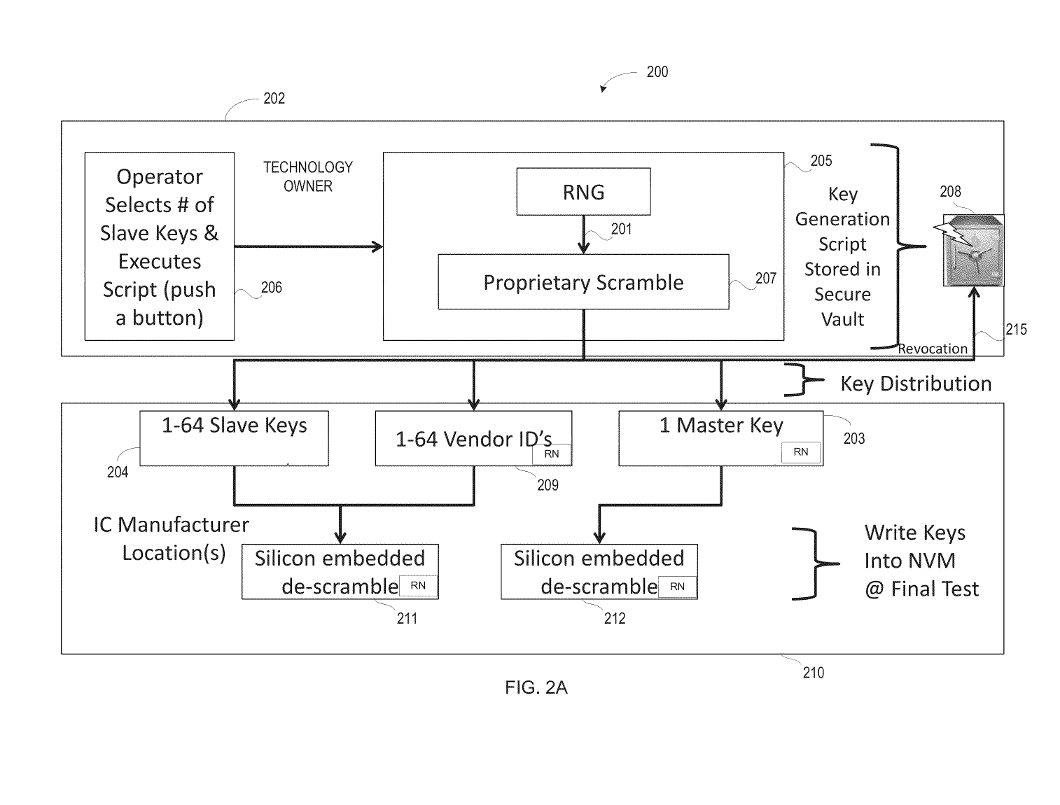

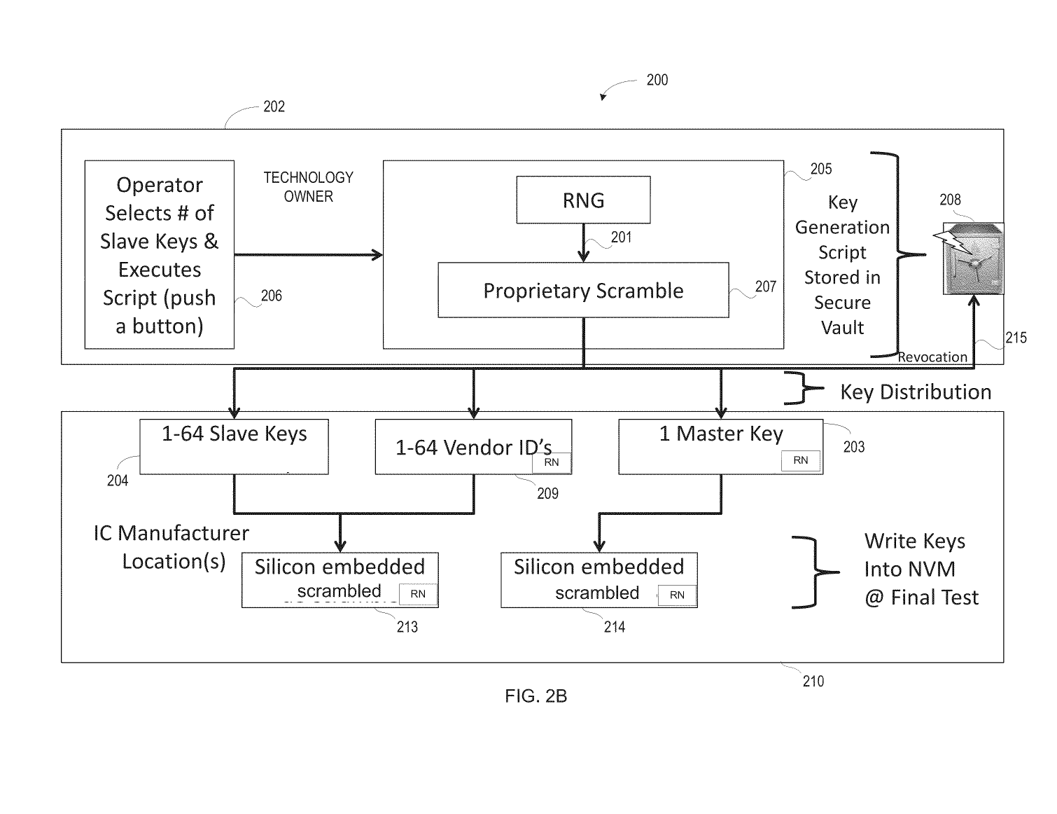

FIGS. 2A and 2B illustrate generally example systems 200 for generating and distributing authentication keys 201 that is less susceptible to an authentication key being leaked. In certain examples, a computer system 205, such as a key generation computer of a technology owner can include or be coupled to an interface 206 for generating sets of authentication keys. One or more processors of the key generation computer system 205 can include a random number generator (RNG) to generate raw authentication keys 201 and a random number (RN). In certain examples, the random number (RN) can be used to scramble the authentication key and/or descramble the authentication key. The one or more processors, or other processors, can immediately run a script 207 to scramble the raw authentication keys 201 such that the raw authentication keys 201 are not viewable. In certain examples, the scrambling script 207 can be stored in a vault 208 at the technology owner location. In certain examples, a set of scrambled authentication keys can include a master authentication key 203, a number of slave authentication keys 204, a number of vendor keys 209 and other keys such as other keys that can augment side channel attack countermeasures.

In certain examples, scrambled keys and an optional random number (RN) used to descramble the authentication keys can be distributed to integrated circuit (IC) manufacturers 210 for inclusion with authentic integrated circuits. In some examples, a descrambling algorithm can be provided to the IC manufacturers and can be embedded into integrated circuits. In certain examples, during final test of the ICs, one or more authentication keys can be loaded into memory of the integrated circuit, such as non-volatile memory (NVM). In the example of FIG. 2A slave authentication keys can be stored in a de-scrambled form 211 in an IC for a slave device along with a random number (RN) provided by the technology owner and a master authentication key can be stored in a de-scrambled form 212 in an IC for a master device along with a random number (RN) provided by the technology owner. In the example of FIG. 2B, the authentication keys can be stored in a scrambled form 213, 214 along with a random number (RN) provided by the technology owner.

FIGS. 2A and 2B also illustrate generally an example revocation method 215. In certain examples, the revocation method 215 can allow the technology owner to revoke an authentication key or a group of authentication keys, for example, after discovering that a particular authentication key has been leaked. The revocation method 215 can also be used to revoke a group of authentication keys, for example, when it is learned that a number of authentication keys from a particular vendor have been compromised. In certain examples, a revocation method 215 for revoking a compromised slave authentication key can include sending a command to a master device to cease using the compromised slave authentication key when authenticating a slave device. In certain examples, slave devices can include more than one slave authentication key such that slave devices legitimately including the compromised slave authentication key can continue to be authenticated. In certain examples, a revocation method for revoking a number of compromised slave authentication keys can include sending a command to a master device to cease using slave authentication keys associated with a certain vendor ID that can be included with the slave authentication keys. In certain examples, slave devices can include more than one slave authentication key such that slave devices legitimately including the compromised slave authentication key can continue to be authenticated. In certain examples, a revocation method can include revoking a compromised master authentication key. In some examples, such a revocation of a master authentication key can render the master unusable with authentic accessory devices. In certain examples, such a revocation of a master authentication key can render certain function of the master device unusable. Such functions can include the ability to couple to certain networks that require authentication, including but not limited to, certain wireless networks and cellular networks.

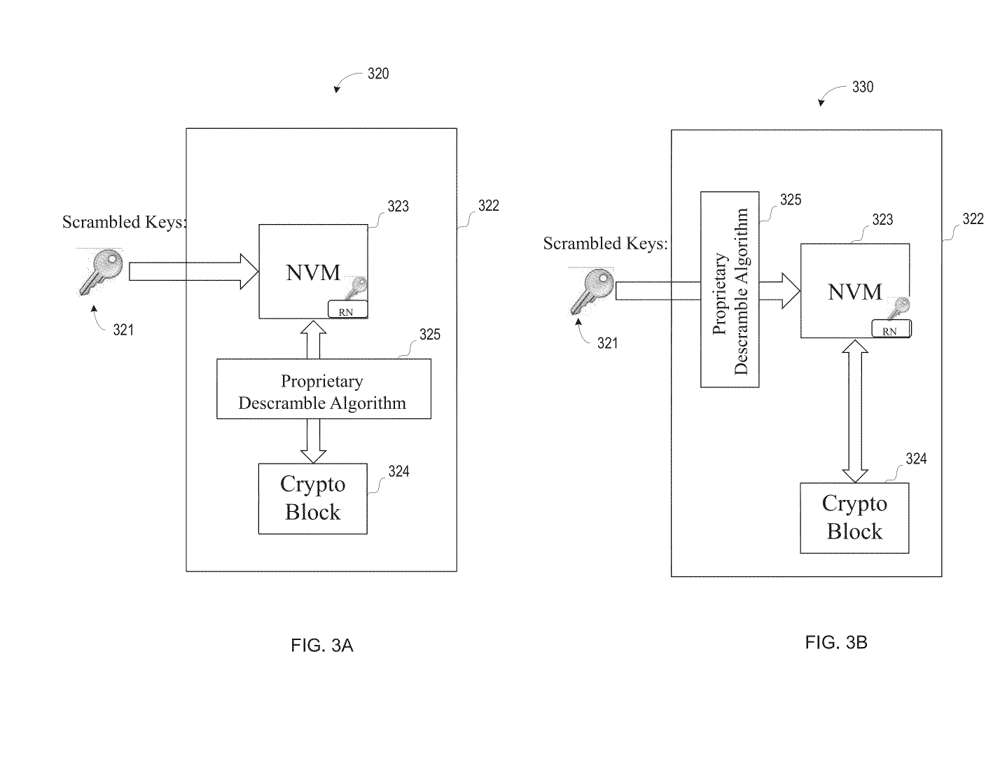

FIG. 3A illustrates generally a method 320 of using an authentication key with a Crypto Block 324 of an integrated circuit 322. In the example, one or more scrambled authentication key 321 can be transferred to an integrated circuit 322 and stored in nonvolatile memory 323 along with an optional random number (RN) received from the technology owner. When the authentication key is requested, for example, from the Crypto Block 324, an embedded descramble algorithm 325 can retrieve and descramble the authentication key. In some examples, a random number (RN) provided by the technology owner can be used to descramble the authentication key. In such an architecture, the raw authentication key is not available to be viewed and, thus, less likely to be leaked.

FIG. 3B illustrates generally a method 330 of using an authentication key with a Crypto Block 324 of an integrated circuit 322. In the example, one or more scrambled authentication keys 321 can be transferred to integrated circuit 322, descrambled using an embedded algorithm 325 and, optionally, a random number (RN) provided by the OEM, and stored in nonvolatile memory 323 along with the random number (RN). The raw authentication key is available in an unscrambled form when requested, for example, by the Crypto Block 324. In such an architecture, the authentication key is not available to be viewed and, thus, less likely to be leaked.

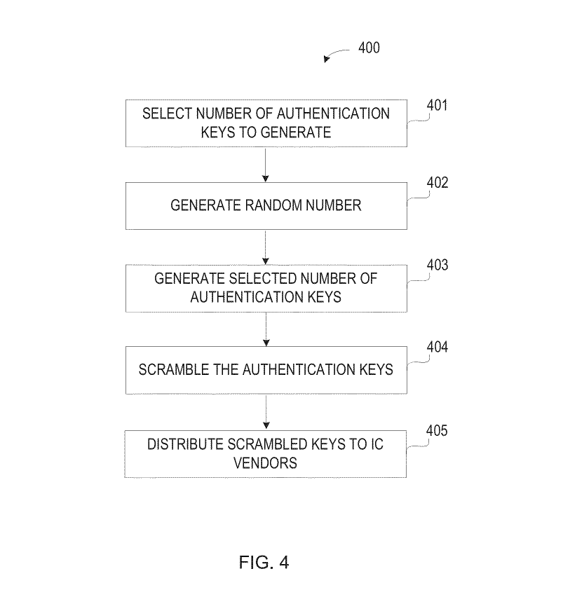

FIG. 4 illustrates generally a flowchart of an example method 400 of distributing authentication keys and preventing circuit fabrication piracy. In certain examples, at 401, the number of authentication keys can be selected for generation at a key generation computer. In certain examples, the technology owner controls the generation of the authentication keys. At 402, a random number can be generated to correspond with one or more of the authentication keys using a random number generator. In certain examples, the key generation computer can include the random number generator. At 403, the number of authentication keys can be generated using the key generation computer and a key generation algorithm. In certain examples, the authentication keys can be generated using the random number. At 404, the authentication keys can be scrambled using a scrambling routine executing on the key generation computer. In certain examples, the authentication keys can be scrambled immediately after generation to prevent opportunities for observing the authentication keys unscrambled. At 405, the scrambled authentication keys can be distributed to the authorized entities associated with final test of the integrated circuits that use the authentication keys. In certain examples, slave authentication keys can be distributed with a vendor ID. In some examples, the master keys can be distributed with a Vendor ID.

In certain examples, the scrambling routine or script used to scramble a set of authentication keys can be securely stored as the scrambling routine or script can provide a counterfeiter with the best opportunity to identify the authentication keys and successfully use the authentication keys for fully functional knock-off devices. In certain examples, the scrambling script or routine may need to be accessed to assist in revoking one or more authentication keys. In certain examples, revocation of an authentication key can include electronically distributing revocation information identifying the revoked key. In some examples, a revocation can include sending revocation commands over a network such as a wireless or cellular network to provide the revocation information to one or more master devices. In certain examples, the technology owner can distribute a descrambling circuit design with the authentication keys. The descrambling circuit can be fabricated with each integrated circuit and used to descramble the authentication keys for authenticating the integrated circuit

In certain examples, an integrated circuit can receive a scrambled authentication key and can save the scrambled authentication key in memory for subsequent use in authenticating the integrated circuit with a connected integrated circuit. In such examples, the scrambled authentication key can be unscrambled when read from the memory. In certain examples, the memory can include non-volatile memory. In certain examples, an integrated circuit can receive a scrambled authentication key, can unscramble the scrambled authentication key and can then save the unscrambled authentication key in memory for subsequent use in authenticating the integrated circuit with a connected integrated circuit. In certain examples, integrated circuits can communicate and authenticate with other integrated circuits over a communication network. Such networks can include, wired networks and wireless networks. In some examples, integrated circuits can communicate and authenticate with other integrated circuits over a serial communication network such as a Universal Serial Bus (USB) network.

### Additional Notes

In Example 1, a method of preventing circuit fabrication piracy can include selecting a number of authentication keys for generation at a key generation computer, generating a random number using a random number generator of the key generation computer, generating the number of authentication keys using the random number and a key generation algorithm stored in the memory of the key generation computer, scrambling each of the number of authentication keys using a scrambling routine executing on the key generation computer, and distributing the scrambled authentication keys to an authorized manufacturers.

In Example 2, the method of Example 1 optionally includes distributing a descrambling circuit design associated with the scrambling routine to the authorized manufacturer.

In Example 3, the number of authentication keys associated with the key generation algorithm of any one or more of Examples 1-2 optionally includes a single master key and one or more slave keys.

In Example 4, the number of authentication keys associated with the key generation algorithm of any one or more of Examples 1-3 optionally includes one or more vendor IDs, wherein one vendor ID of the one or more vendor IDs is configured to identify the authorized manufacturer.

In Example 5, the distributing the scrambled authentication keys to an authorized manufacturer of any one or more of Examples 1-4 optionally includes distributing a vendor ID to the authorized manufacturer.

In Example 6, the method of any one or more of Examples 1-5 optionally includes electronically distributing revocation information identifying a revoked slave key.

In Example 7, a method of preventing circuit fabrication piracy can include receiving a plurality of scrambled authentication keys at an authorized manufacturer from an entity associated with a design of an integrated circuit, wherein the authorized manufacturer is authorized to manufacture the integrated circuit, is authorized to manufacture a master electronic device using the integrated circuit, or is authorized to manufacture an accessory using the integrated circuit, wherein the accessory is configured to couple to the master electronic device, and electronically saving a representation of an authentication key in a memory location of the integrated circuit during a final test stage of the integrated circuit.

In Example 8, the authorized manufacturer is authorized to manufacture the integrated circuit and the method of any one or more of Examples 1-7 optionally includes receiving a descrambling circuit design from the entity.

In Example 9, the method of any one or more of Examples 1-8 optionally includes manufacturing a descrambling circuit according to the descrambling circuit design.

In Example 10, the electronically saving the representation of an authentication key of any one or more of Examples 1-9 optionally includes electronically saving the representation of the authentication key in non-volatile memory of the integrated circuit.

In Example 11, the electronically saving a representation of an authentication key of any one or more of Examples 1-10 optionally includes descrambling the scrambled authentication key using the descrambling circuit to provide the representation of the authentication key to the non-volatile memory for saving.

In Example 12, the embedded integrated circuit of the accessory device of any one or more of Examples 1-9 optionally includes a cryptography circuit, and the method of any one or more of Examples 1-9 optionally includes receiving authentication information at the integrated circuit, and providing encrypted authentication information using the cryptography circuit and an authentication key derived from the representation of the authentication key saved in the non-volatile memory.

In Example 13, the representation of the authentication key of any one or more of Examples 1-12 optionally includes the scrambled authentication key, and the providing encrypted authentication information of any one or more of Examples 1-12 optionally includes retrieving the scrambled authentication key from the non-volatile memory, and descrambling the scrambled authentication key using the descrambling circuit to provide the authentication key to the cryptography circuit.

In Example 14, an accessory for a master electronic device can include a communication port, and an integrated circuit chip coupled to the communication port and configured to receive a scrambled representation of an authentication key, the integrated circuit including a descrambling circuit configured to descramble the scrambled representation of an authentication key to provide the authentication key, non-volatile memory configured to store a representation of the authentication key, and a cryptography circuit configured to receive authentication information and to provide an encrypted authentication key using the authentication information and the authentication key.

In Example 15, the representation of the authentication key of any one or more of Examples 1-14 optionally includes the scrambled representation of the authentication key.

In Example 16, the representation of the authentication key of any one or more of Examples 1-15 optionally includes the authentication key.

In Example 17, the communication port of any one or more of Examples 1-16 optionally includes a Universal Serial Bus (USB) port.

In Example 18, the communication port of any one or more of Examples 1-17 optionally includes a wireless communication port.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A method of preventing circuit fabrication piracy, the method comprising:
selecting a number of authentication keys for generation at a key generation computer;
generating a random number using a random number generator of the key generation computer;
generating the number of authentication keys using the random number and a key generation algorithm stored in the memory of the key generation computer;
scrambling each of the number of authentication keys using a scrambling routine executing on the key generation computer; and
distributing the scrambled authentication keys to an authorized manufacturers.

2. The method of claim 1, including distributing a descrambling circuit design associated with the scrambling routine to the authorized manufacturer.

3. The method of claim 1, wherein the number of authentication keys associated with the key generation algorithm includes a single master key and one or more slave keys.

4. The method of claim 3, wherein the number of authentication keys associated with the key generation algorithm includes one or more vendor IDs, wherein one vendor ID of the one or more vendor IDs is configured to identify the authorized manufacturer.

5. The method of claim 4, wherein the distributing the scrambled authentication keys to an authorized manufacturer includes distributing a vendor ID to the authorized manufacturer.

6. The method of claim 3, including electronically distributing revocation information identifying a revoked slave key.

7. A method of preventing circuit fabrication piracy, the method comprising:
receiving a plurality of scrambled authentication keys at an authorized manufacturer from an entity associated with a design of an integrated circuit, wherein the authorized manufacturer is authorized to manufacture the integrated circuit, is authorized to manufacture a master electronic device using the integrated circuit, or is authorized to manufacture an accessory using the integrated circuit, wherein the accessory is configured to couple to the master electronic device; and
electronically saving a representation of an authentication key in a memory location of the integrated circuit during a final test stage of the integrated circuit.

8. The method of claim 7, wherein the authorized manufacturer is authorized to manufacture the integrated circuit, and the method includes receiving a descrambling circuit design from the entity.

9. The method of claim 8, wherein the method includes manufacturing a descrambling circuit according to the descrambling circuit design.

10. The method of claim 8, wherein the electronically saving the representation of an authentication key includes electronically saving the representation of the authentication key in non-volatile memory of the integrated circuit.

11. The method of claim 10, wherein electronically saving a representation of an authentication key includes descrambling the scrambled authentication key using the descrambling circuit to provide the representation of the authentication key to the non-volatile memory for saving.

12. The method of claim 10, wherein the embedded integrated circuit of the accessory device includes a cryptography circuit; and
the method includes:
receiving authentication information at the integrated circuit; and
providing encrypted authentication information using the cryptography circuit and an authentication key derived from the representation of the authentication key saved in the non-volatile memory.

13. The method of claim 12, wherein the representation of the authentication key includes the scrambled authentication key; and
wherein the providing encrypted authentication information includes:
retrieving the scrambled authentication key from the non-volatile memory;
descrambling the scrambled authentication key using the descrambling circuit to provide the authentication key to the cryptography circuit.

14. An accessory for a master electronic device, the accessory comprising:
a communication port; and
an integrated circuit chip coupled to the communication port and configured to receive a scrambled representation of an authentication key, the integrated circuit including:
a descrambling circuit configured to descramble the scrambled representation of an authentication key to provide the authentication key;
nonvolatile memory configured to store a representation of the authentication key; and
a cryptography circuit configured to receive authentication information and to provide an encrypted authentication key using the authentication information and the authentication key.

15. The accessory device of claim 14, wherein the representation of the authentication key includes the scrambled representation of the authentication key.

16. The accessory device of claim 14, wherein the representation of the authentication key includes the authentication key.

17. The accessory device of claim 14, wherein the communication port includes a Universal Serial Bus (USB) port.

18. The accessory device of claim 14, wherein the communication port includes a wireless communication port.
